(19) United States
(12) Patent Application Publication
(10) Pub. No.: US 2011/0062788 A1
(43) Pub. Date: Mar. 17, 2011

(54) Wirless power supply device

(76) Inventors: Yung-Hsiang Chen, Tu-Cheng City (TW); Nan-Sheng Chang, Tu-Cheng City (TW); Yung-Hsin Liang, Tu-Cheng City (TW)

(21) Appl. No.: 12/585,527

(22) Filed: Sep. 17, 2009

(51) Int. Cl. H02J 17/00

(52) U.S. Cl. 307/104

(57) ABSTRACT

A wireless power supply device is adapted for providing electric power to an exterior electronic appliance. The wireless power supply includes a transmitting unit and a receiving unit. The transmitting unit includes a power unit for providing power to a voltage-controlled oscillator circuit and a signal amplification unit, the voltage-controlled oscillator circuit for receiving the power and then generating corresponding radio signals, the signal amplification unit for amplifying the radio signals generated by the voltage-controlled oscillator circuit and a transmitting antenna module for transmitting out the radio signals amplified by the signal amplification unit. The receiving unit includes a receiving antenna for wirelessly receiving the radio signals transmitted by the transmitting antenna module and then transforming the radio signals into electric power for being provided to the exterior electronic appliance.

### BACKGROUND OF THE INVENTION

1. Field of the Invention

The present invention generally relates to a power supply device, and more particularly to a wireless power supply device.

2. The Related Art

Generally speaking, a mobile low-power electronic product such as a mobile phone, a mouse and so on needs a power-storage device such as a battery for providing electric power to the mobile low-power electronic product. When the electric power of the power-storage device is depleted, users must charge the power-storage device by means of a power supply device. A conventional power supply device wirelessly transmits an electromagnetic wave generated by a magnetic induction coil therein, and then transforms the electromagnetic wave into electric power for the power-storage device. However, the power supply device can be only used in a short range because the frequency of the electromagnetic wave is relatively low, so the electromagnetic wave is attenuated rapidly that results in an inconvenience of charging the power-storage device. Therefore, a power supply device capable of overcoming the foregoing problem is required.

### SUMMARY OF THE INVENTION

An object of the present invention is to provide a wireless power supply device. The wireless power supply device is adapted for providing electric power to an exterior electronic appliance. The wireless power supply includes a transmitting unit and a receiving unit. The transmitting unit includes a power unit for providing power to a voltage-controlled oscillator circuit and a signal amplification unit, the voltage-controlled oscillator circuit for receiving the power and then generating corresponding radio signals, the signal amplification unit for amplifying the radio signals generated by the voltage-controlled oscillator circuit and a transmitting antenna module for transmitting out the radio signals amplified by the signal amplification unit. The receiving unit includes a receiving antenna for wirelessly receiving the radio signals transmitted by the transmitting antenna module and then transforming the radio signals into electric power for being provided to the exterior electronic appliance.

As described above, the wireless power supply device of the present invention utilizes the transmitting unit transmitting out the radio signals, and the receiving unit wirelessly receiving the radio signals and then transforming the radio signals into the electric power so as to provide the electric power to the exterior electronic appliance. The radio signal has a good anti-attenuation ability and can be transmitted in a relatively long range, so it is convenient to provide the electric power to the exterior electronic appliance.

### BRIEF DESCRIPTION OF THE DRAWINGS

The present invention will be apparent to those skilled in the art by reading the following description, with reference to the attached drawings, in which:

FIG. 1 is a block diagram of a wireless power supply device according to the present invention;

FIG. 2 is a circuitry of a voltage-controlled oscillator circuit of the wireless power supply device of FIG. 1;

FIG. 3 is a view of a transmitting antenna module of the wireless power supply device of FIG. 1; and

FIG. 4 is a circuitry of a rectifying circuit of the wireless power supply device of FIG. 1.

### DETAILED DESCRIPTION OF THE PREFERRED EMBODIMENT

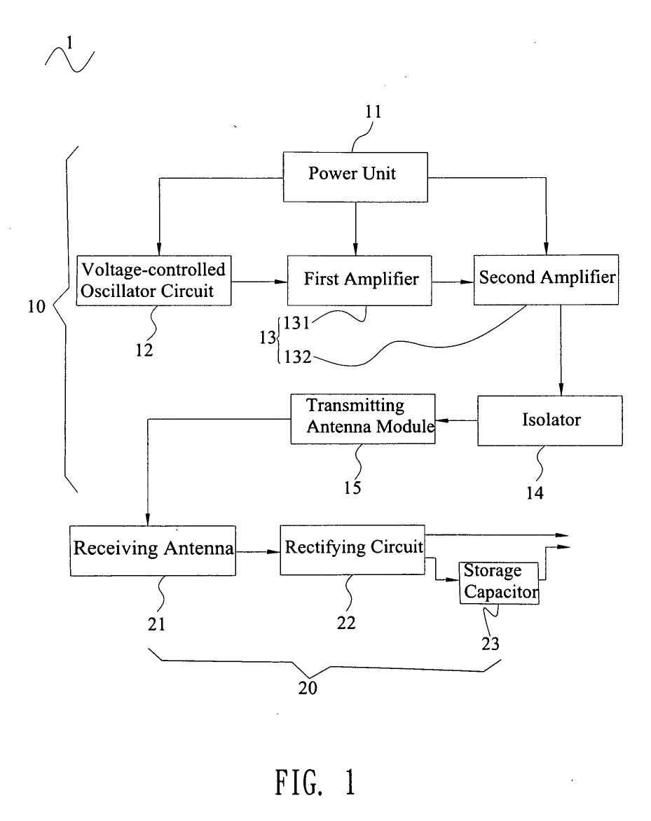

Referring to FIG. 1, a wireless power supply device 1 according to the present invention includes a transmitting unit 10 and a receiving unit 20. The wireless power supply device 1 is used for providing electric power to a mouse (not shown) in this embodiment.

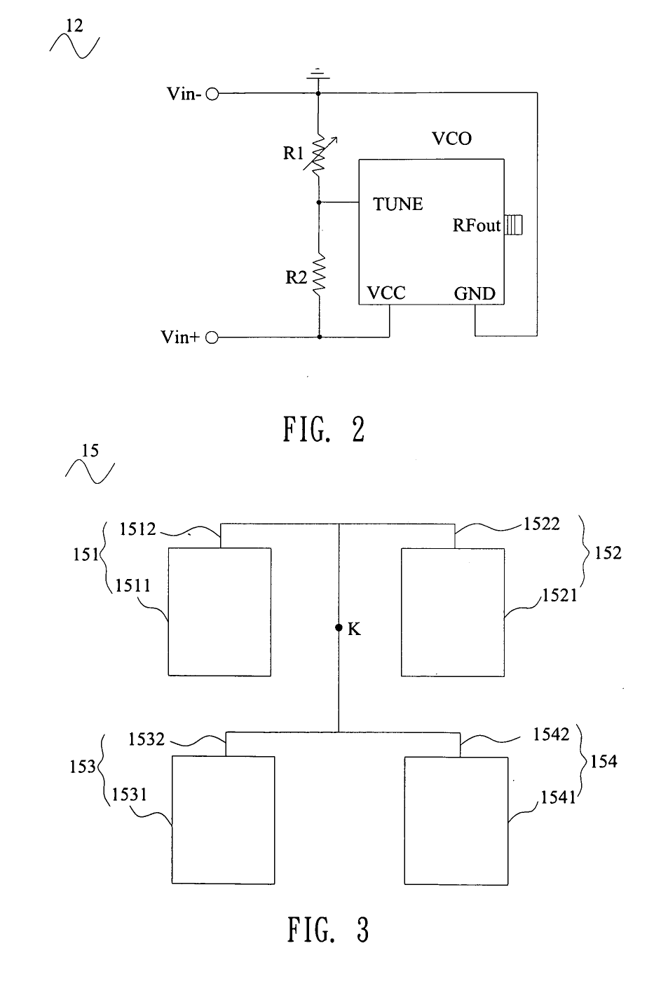

Referring to FIG. 1 and FIG. 2, the transmitting unit 10 of the wireless power supply device 1 includes a power unit 11, a voltage-controlled oscillator circuit 12, a signal amplification unit 13, an isolator 14 and a transmitting antenna module 15. The power unit 11 is connected with the voltage-controlled oscillator circuit 12 and the signal amplification unit 13 for providing power to the voltage-controlled oscillator circuit 12 and the signal amplification unit 13. In this embodiment, the power unit 11 is provided with 6V. The voltage-controlled oscillator circuit 12 includes a voltage-controlled oscillator VCO. The voltage-controlled oscillator VCO has a first pin TUNE, a second pin VCC, a third pin GND and a fourth pin RFout. The second pin VCC is drawn forth as a positive input terminal Vin+connected to the power unit 11, and the third pin GND is drawn forth as a negative input terminal Vin− connected to ground. The first pin TUNE is on one hand connected to the positive input terminal Vin+ through a second resistor R2, and on the other hand connected to the negative input terminal Vin− through a first resistor R1. The fourth pin RFout is electrically connected with the signal amplification unit 13. In this embodiment, the first resistor R1 is a variable resistor. The voltage-controlled oscillator VCO is used for generating radio signals, and output frequency thereof is variable on account of a variable resistance of the first resistor R1. In this embodiment, the voltage-controlled oscillator VCO is able to output a radio signal with a frequency of 2.4 GHz.

Referring to FIG. 1 and FIG. 2 again, the signal amplification unit 13 used for amplifying the output radio signal from the voltage-controlled oscillator circuit 12 includes a first amplifier 131 and a second amplifier 132. In this embodiment, the first amplifier 131 is a signal amplifier with a gain of 17.5 dB in condition that the output frequency of the voltage-controlled oscillator VCO is 2.4 GHz. The second amplifier 132 is a power amplifier and a gain of the second amplifier 132 is 14 dB with an output power of 1 W. One terminal of the first amplifier 131 is connected with the fourth pin RFout of the voltage-controlled oscillator VCO and another terminal of the first amplifier 131 is connected with the second amplifier 132. One terminal of the isolator 14 is connected with the second amplifier 132 and the other terminal of the isolator 14 is connected with a feeding point K of the transmitting antenna module 15 for preventing the second amplifier 132 from being damaged by the reflection signal of the transmitting antenna module 15.

Referring to FIG. 1 and FIG. 3, the transmitting antenna module 15 includes a plurality of slice antennas 151, 152, 153, 154 arranged at a phased array and connected to the feeding point K respectively. Each of the slice antennas 151, 152, 153, 154 has a substantial rectangular radiation portion 1511/1521/1531/1541 and a connecting portion 1512/1522/1532/1542 connecting the corresponding radiation portion 1511/1521/1531/1541 to the feeding point K. The connecting portions 1512, 1522, 1532, 1542 have substantially equal lengths with one another so as to make the amplified radio signals feed back to the feeding point K by means of a substantial in-phase feed back. In this embodiment, the length of each of the radiation portions 1511, 1521, 1531, 1541 is substantially equal to a half of the wavelength of the radio signal generated by the voltage-controlled oscillator VCO. The transmitting antenna module 15 has a relatively high gain and a relatively large half-power beamwidth.

Referring to FIG. 1 again, the receiving unit 20 is disposed in the mouse and includes a receiving antenna 21, a rectifying circuit 22 electrically connected with the receiving antenna 21, and a storage capacitor 23 electrically connected with the rectifying circuit 22. The rectifying circuit 22 is further directly connected with a circuit of the mouse, and the storage capacitor 23 is also connected with the circuit of the mouse. The receiving antenna 21 is used for wirelessly receiving the radio signals transmitted by the transmitting antenna module 15 and then transforming the radio signals into electric power. In this embodiment, the receiving antenna 21 is a dipole antenna with a feeding portion (not shown) and a grounding portion (not shown).

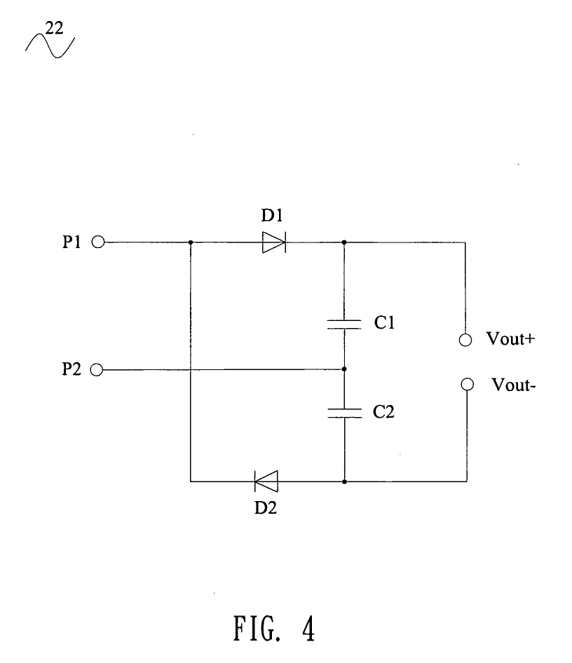

Referring to FIG. 1 and FIG. 4, the rectifying circuit 22 has functions of a voltage multiplier and a full-wave rectifier. The rectifying circuit 22 is used for rectifying the electric power from the receiving antenna 21 and includes a first diode D1, a first capacitor C1, a second capacitor C2 and a second diode D2 successively connected with one another in series to form a unidirectional path. A first input terminal P1 is drawn forth from the connection location of the first diode D1 and the second diode D2. A second input terminal P2 is drawn forth from the connection location of the first capacitor C1 and the second capacitor C2. The first input terminal P1 and the second input terminal P2 are electrically connected with the feeding portion and the grounding portion of the dipole antenna, respectively. A positive output terminal Vout+ is drawn forth from the connection location of the first diode D1 and the first capacitor C1. A negative output terminal Vout− is drawn forth from the connection location of the second diode D2 and the second capacitor C2. The positive output terminal Vout+ and the negative output terminal Vout− are on one hand directly connected with the circuit of the mouse, and on the other hand connected with the storage capacitor 23. The rectifying circuit 22 provides the rectified electric power to the mouse directly when the mouse is in the effective transmission range of the radio signals transmitted by the transmitting antenna module 15, and simultaneously charges the storage capacitor 23 with the rectified electric power. When the mouse is out of the effective transmission range of the radio signals transmitted by the transmitting antenna module 15, the storage capacitor 23 provides the stored electric power to the mouse. In this embodiment, both the first diode D1 and the second diode D2 are schottky diodes for enhancing a switching efficiency of the rectifying circuit 22. The storage capacitor 23 is an ultra-capacitor so as to store enough electric power for the mouse when the mouse is out of the effective transmission range of the radio signals.

As described above, the wireless power supply device 1 of the present invention utilizes the transmitting unit 10 transmitting out the radio signals, and the receiving unit 20 wirelessly receiving the radio signals and then transforming the radio signals into the electric power so as to provide the electric power to the mouse. The radio signal has a good anti-attenuation ability and can be transmitted in a relatively long range, so it is convenient to store the electric power in the storage capacitor 23 and further provide the electric power to the mouse.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A wireless power supply device adapted for providing electric power to an exterior electronic appliance, comprising:
a transmitting unit including
a power unit for providing power to a voltage-controlled oscillator circuit and a signal amplification unit,
the voltage-controlled oscillator circuit for receiving the power and then generating corresponding radio signals,
the signal amplification unit for amplifying the radio signals generated by the voltage-controlled oscillator circuit, and
a transmitting antenna module for transmitting out the radio signals amplified by the signal amplification unit; and
a receiving unit including a receiving antenna for wirelessly receiving the radio signals transmitted by the transmitting antenna module and then transforming the radio signals into electric power for being provided to the exterior electronic appliance.

2. The wireless power supply device as claimed in claim 1, wherein the signal amplification unit includes a signal amplifier and a power amplifier.

3. The wireless power supply device as claimed in claim 1, wherein the transmitting antenna module includes a plurality of slice antennas arranged at a phased array, each of the slice antennas has a radiation portion and a connecting portion connecting the radiation portion to a feeding point of the transmitting antenna module.

4. The wireless power supply device as claimed in claim 3, wherein the connecting portions have substantially equal lengths with one another so as to make the amplified radio signals feed back to the feeding point by means of a substantial in-phase feed back.

5. The wireless power supply device as claimed in claim 3, wherein each of the radiation portions is of substantially rectangular shape and the length thereof substantially equals to a half of wavelength of the radio signal generated by the voltage-controlled oscillator circuit.

6. The wireless power supply device as claimed in claim 1, wherein the receiving unit further includes a storage capacitor for storing certain electric power therein when the exterior electronic appliance is in the effective transmission range of the radio signals transmitted by the transmitting antenna module, and providing the stored electric power to the exterior electronic appliance when the exterior electronic appliance is out of the effective transmission range of the radio signals transmitted by the transmitting antenna module.

7. The wireless power supply device as claimed in claim 6, wherein the storage capacitor is an ultra-capacitor.

8. The wireless power supply device as claimed in claim 1, wherein the receiving unit further includes a rectifying circuit for rectifying the electric power transformed by the receiving antenna and then providing the rectified electric power to the exterior electronic appliance.

9. The wireless power supply device as claimed in claim 8, wherein the rectifying circuit has functions of a voltage multiplier and a full-wave rectifier.

10. The wireless power supply device as claimed in claim 1, wherein the transmitting unit further includes an isolator connected between the signal amplification unit and the transmitting antenna module for preventing the signal amplification unit from being damaged by reflection signal from the transmitting antenna module.
